(19) United States
(12) Patent Application Publication
(10) Pub. No.: US 2025/0300489 A1
(43) Pub. Date: Sep. 25, 2025

(54) POWER AND BACKUP SYSTEM FOR LOW POWER OUTDOOR APPLICATIONS

(71) Applicant: viaPhoton, Inc., Aurora, IL (US)

(72) Inventor: Steve FISCHER, Windsor, CO (US)

(21) Appl. No.: 19/084,411

(22) Filed: Mar. 19, 2025

Related U.S. Application Data
(60) Provisional application No. 63/567,305, filed on Mar. 19, 2024.

(51) Int. Cl. H02J 9/06; H02J 7/00

(52) U.S. Cl. CPC H02J 9/066; H02J 7/0063

(57) ABSTRACT

A power backup system is provided for low power outdoor applications. The power backup system comprises a generator, a battery pack, a bus connecting the generator to the battery pack, and a current manager. The battery pack is connected to the bus in a series of parallel conductor paths. A voltage drop across a selected conductor path is different than other voltage drops across the other conductor paths. The current manager is configured to manage current between the generator and the battery pack based on bus voltage.

### CROSS-REFERENCE TO RELATED APPLICATIONS

This application claims the benefit of U.S. Provisional Application Ser. No. 63/567,305, filed Mar. 19, 2024, which is hereby incorporated by reference for all purposes.

### BACKGROUND

Power backup systems are widely used in environments where continuous operation of electrical loads is necessary despite interruptions in commercial power. These systems typically rely on generators, battery storage, or a combination of both to supply power during outages. In many configurations, a generator serves as the primary backup power source, while batteries provide temporary energy until the generator reaches operational status. Managing the transition between power sources presents several challenges, particularly in maintaining power stability, preventing electrical surges, and ensuring efficient energy utilization.

A common issue in conventional backup power systems is the management of inrush current when transitioning between battery storage and generator power. When commercial power is lost, batteries discharge to support the load. Upon restoration of generator power, both the load and the battery recharging requirements can create a surge in current demand. This surge can lead to generator overloading, tripping of circuit breakers, or the need for oversized generators with increased fuel consumption and operational costs. Additionally, rapid transitions between power sources can introduce voltage fluctuations that compromise the stability of connected electrical equipment.

Furthermore, standby generators require periodic operation to maintain engine readiness, typically achieved through maintenance cycles that burn fuel without generating useful power. These maintenance cycles contribute to unnecessary fuel consumption, increased emissions, and additional maintenance costs. Battery storage, especially in low-capacity systems, also presents issues related to self-discharge and premature depletion due to parasitic loads, leading to reduced shelf life and the potential for operational failure if not effectively managed.

### SUMMARY

In general, in one aspect, one or more examples relate to a power backup system. The power backup system comprises a generator, a battery pack, a bus connecting the generator to the battery pack, and a current manager. The battery pack is connected to the bus in a series of parallel conductor paths. A voltage drop across a selected conductor path is different than other voltage drops across the other conductor paths. The current manager is configured to manage current between the generator and the battery pack based on bus voltage.

In another aspect, one or more examples relate to a current manager for managing a current between a generator and a battery pack based on bus voltage. The current manager comprises a series of parallel conductor paths connecting the battery pack to the bus. Each of the parallel conductor paths comprises a resistor, a Peltier module, and a photocell stack. The Peltier module is configured to be coupled to an oil sump of a mechanical motor of a compressor. The photocell stack is configured to be photocoupled to a bus that supplies external power. The voltage drop across a selected conductor path is different than the voltage drops across the other conductor paths.

In another aspect, one or more examples relate to a method for managing current between a generator and a battery pack. The method comprises: connecting the battery pack to a bus in a series of parallel conductor paths; monitoring a flow direction of current between the generator and the battery pack; discharging the battery pack into a load in response to a failure of an external power supply; and reconnecting the battery pack to the load when voltage from the battery pack is about equal to the voltage from the bus. The parallel conductor paths sequentially dissipate current supplied to the battery pack.

Other aspects of the invention will be apparent from the following description and the appended claims.

### BRIEF DESCRIPTION OF DRAWINGS

FIG. 1 shows a block diagram of a power backup system in accordance with one or more embodiments of the invention.

FIGS. 2A and 2B show an example of a current manager in accordance with one or more embodiments of the invention.

FIGS. 3A and 3B show a circuit diagram of a current manager in accordance with one or more embodiments of the invention.

FIG. 4 shows a high-level flowchart for managing current between a generator and a battery pack in accordance with one or more embodiments of the invention.

FIG. 5 shows a more detailed flowchart for managing current between a generator and a battery pack in accordance with one or more embodiments of the invention.

FIG. 6 shows a flowchart for generator maintenance cycling in accordance with one or more embodiments of the invention.

FIG. 7 shows a flowchart for battery storage hibernation in accordance with one or more embodiments of the invention.

FIG. 8 shows a computing system in accordance with one or more embodiments of the invention.

Like elements in the various figures are denoted by like reference numerals for consistency.

### DETAILED DESCRIPTION

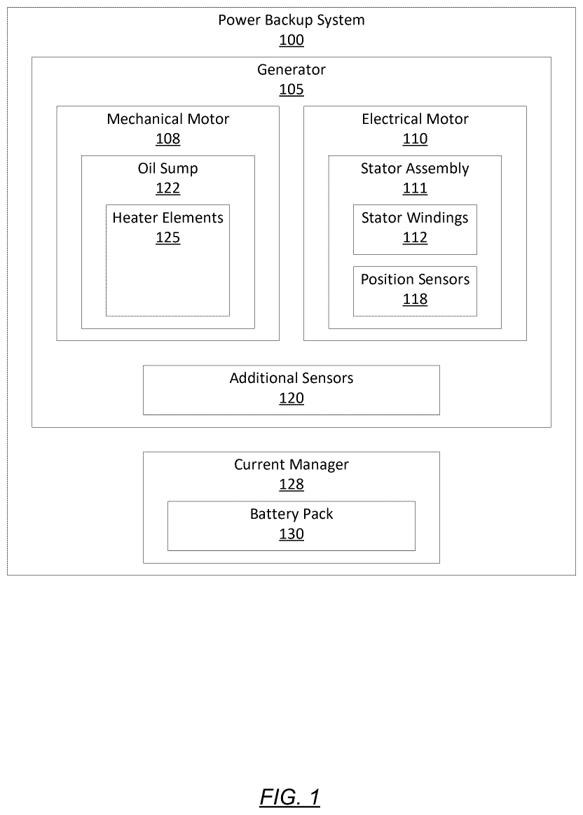

FIG. 1 shows a block diagram of a power backup system (100) according to illustrative embodiments. The power backup system (100) coordinates generator operation, current management, and battery storage through integrated control logic, enabling fuel-less maintenance, inrush current mitigation, and battery hibernation.

As shown, the power backup system (100) includes a generator (105), a current manager (128), and a battery pack (130). The generator (105) comprises a mechanical motor (108) and an electrical motor (110).

The mechanical motor (108) includes an oil sump (122), and heater elements (125) configured to heat the oil sump (122) during maintenance operations. The mechanical motor (108) may be a combustion motor that burns fuel to turn the electrical motor (110) to generate power for a remote system. The operating speed of the mechanical motor (108) may be measured in revolutions per minute (rpm).

The electrical motor (110) holds a stator assembly (111) with stator windings (112) and position sensors (118). In an embodiment, the stator windings (112) of the electrical motor (110) are in place for 3-phase power generation when the electrical motor (110) is driven by the mechanical motor (108). During a fuel-less maintenance cycle, instead of the electrical motor (110) being driven by the mechanical motor (108), the stator windings (112) and are modulated using the trapezoid waveforms (115) for commutation to turn the mechanical motor (108) of the generator (105) at the normal operating speeds. The stator windings (112) are configured to receive trapezoidal waveforms for commutation, allowing rotation of the mechanical motor (108) without combustion during maintenance cycles.

The generator (105) is connected to the current manager (128), which regulates current between the generator (105) and the battery pack (130). The current manager (128) manages power transitions based on bus voltage, ensuring controlled energy flow during charging and discharging operations. The battery pack (130) is coupled to the bus through a series of parallel conductor paths, each showing a different voltage drop, allowing staged dissipation of inrush current.

For proper commutation of the electrical motor (110), the crank position of the mechanical motor (108) is monitored. The cam position of the mechanical motor (108) may also be monitored to determine the compression stroke. The monitoring may be performed by inserting the position sensors (118) into the stator assembly (111) of the electrical motor (110). The position sensors (118) provide data for determining crank and cam position, which are used for controlling engine cycling and evaluating compression stroke pressure. The position sensors (118) may be hall effect sensors, optical sensors, reluctance sensors, etc.

Additional sensors (120) interface with both the mechanical motor (108) and the electrical motor (110) to monitor system parameters, including temperature, moisture levels, and ignition status.

As part of the fuel-less maintenance cycle, engine oil is heated in order to expel moisture. Heater elements (125) are positioned within the oil sump (122) to raise the temperature of engine oil to a predefined threshold before rotation of the mechanical motor (108) begins.

The system (100) further includes the current manager (128) and the battery pack (130), which may be referred to as a bridging battery.

The current manager (128) includes a circuit card assembly that contains processors and memory devices, and resident software for management of power system components. The current manager (128) integrates, coordinates, and executes the previously described functions.

The current manager (128) reduces peak battery inrush current demands on a power system. In a telecommunications power system with battery and/or generator backup power, the current manager (128) reduces current peaks and site costs required to support the higher current levels that would exist without the current manager (128).

For example, when commercial power is restored to a site that has lost power. In this scenario, spent batteries pull charging current and site equipment may also draw current for operation. The current manager (128) will reduce the current draw of the batteries and reduce current demand spiking of the overall power system. The reduction in current draw at the site reduces the cost of the overall power system as it can be designed for lower current levels (smaller generators, lower cost conductors, and circuit breakers).

In some embodiments, the current manager (128) includes Peltier devices, diodes, and resistors. The Peltier devices, diodes, and resistors are connected in series in multiple conductor paths. The conductor paths are parallel paths between backup batteries and the load. Each parallel path has a different group of components so that the voltage drop across each path is different. As battery float voltage changes during charge or recharge, the parallel conductor paths of the current manager (128) will sequentially dissipate re-charge energy. This ‘damping’ of inrush current serves to reduce the max current supply required of the generator. Consequently, smaller generators may be used.

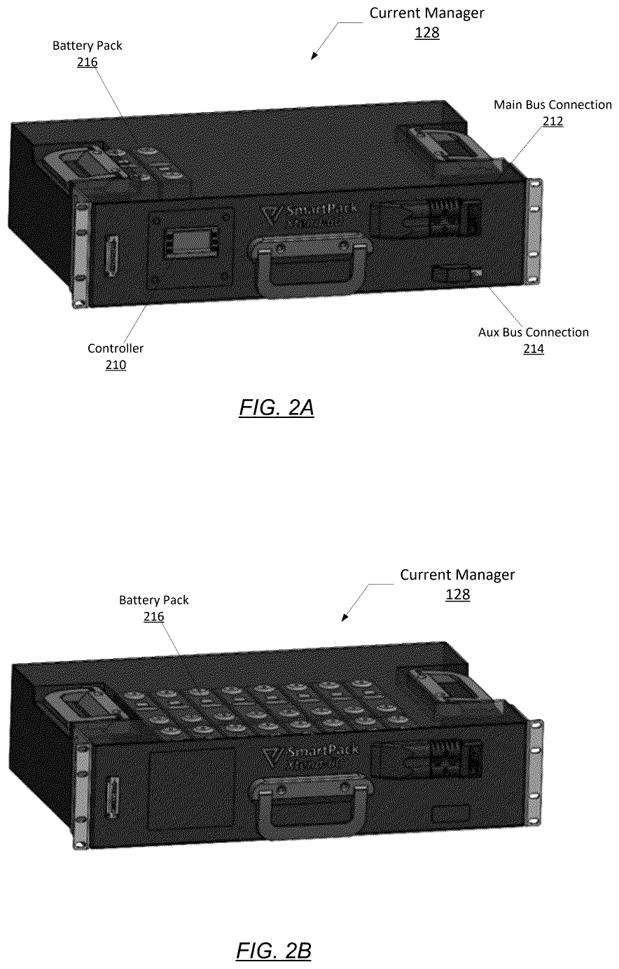

Turning to FIGS. 2A and 2B, an example of a current manager is shown according to illustrative embodiments. In the embodiment illustrated in FIG. 2, the current manager (128) is structured to fit into a standard server rack. In an embodiment, the current manager (128) may be sized to take at least three rack units (RUS) within a server rack. The current manager (128) includes the battery pack (202) and the controller interface (205).

The current manager (128) houses a battery pack (216) and includes multiple electrical connections. The battery pack (216) is electrically coupled to the current manager (128) and is structured to store and discharge electrical energy. The battery pack (202) includes a set of battery cells. In an embodiment, the battery cells used are a lithium iron phosphate (LiFePo) chemistry.

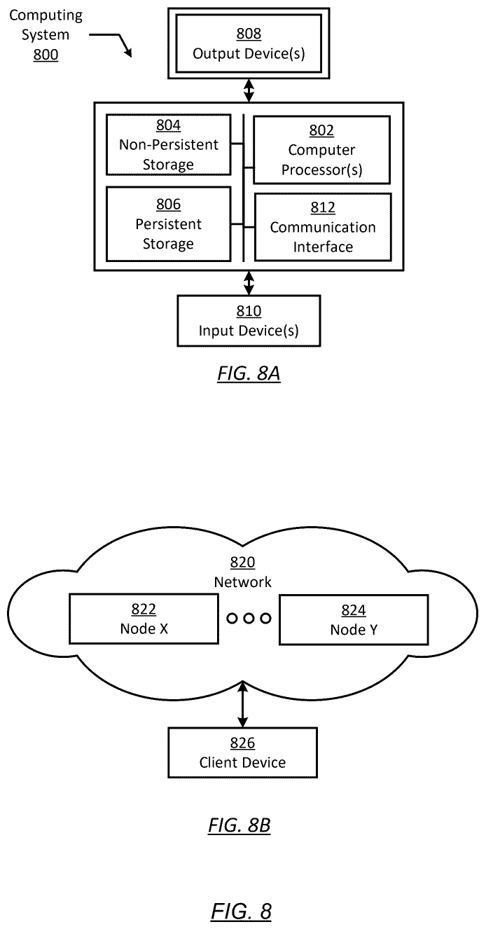

The current manager (128) includes a controller (210) configured to regulate current flow between the generator and the battery pack (216). The controller (210) is in communication with internal circuit components that control charge and discharge operations. The controller (210) is accessible through an interface on the front panel. The controller interface (205) provides a human interface to the control system of the management system (200). The controller (210) may include a computing system, such as the one described in FIG. 8.

A main bus connection (212) provides an electrical connection for power distribution. An auxiliary bus connection (214) is positioned adjacent to the main bus connection (212) and facilitates additional power or control signaling. The current manager (128) includes multiple access points for monitoring and system integration.

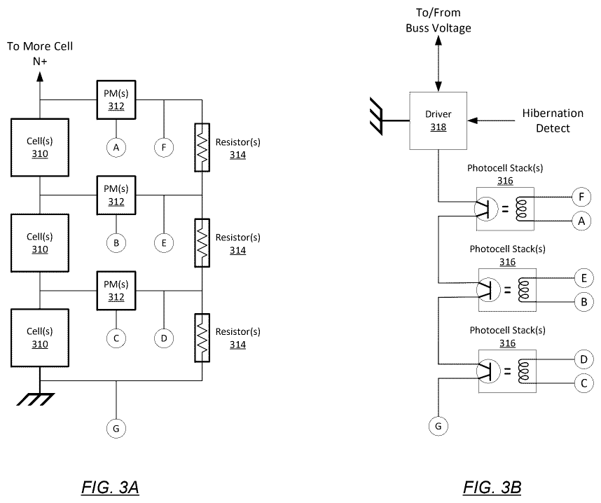

FIGS. 3A and 3B illustrate a circuit diagram of a current manager according to illustrative embodiments. As shown, the current manager (128) is structured to regulate current flow between a generator and a battery pack. The circuit includes multiple parallel conductor paths, each comprising a combination of components that control current dissipation.

In FIG. 3A, a set of cells (110) is connected in series to provide energy storage. Each cell (110) is coupled to a Peltier module (PM) (112) and a resistor (314). The Peltier module (112) is structured to transfer heat energy based on electrical input. The resistor (314) is positioned within each conductor path to regulate current flow. Each conductor path is labeled with an identifier (A, B, C, D, E, F), which corresponds to specific dissipation stages.

In FIG. 3B, a driver (318) is configured to receive bus voltage input and detect hibernation conditions. The driver (318) is connected to a set of photocell stacks (316), each associated with a respective conductor path. The photocell stacks (316) control switching elements within the circuit. The driver (318) regulates power distribution to and from the battery pack based on detected system conditions. Each photocell stack (316) is linked to a respective dissipation stage (A, B, C, D, E, F), enabling staged current dissipation.

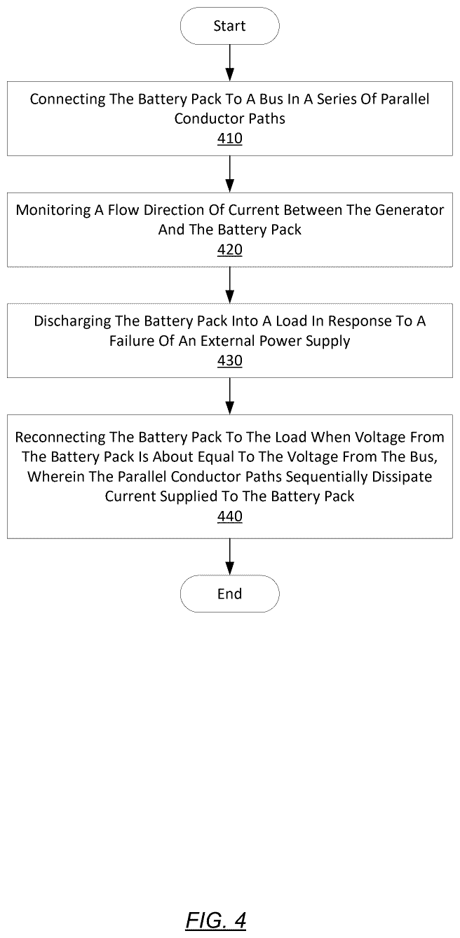

FIG. 4 is a high-level flowchart for managing current between a generator and a battery pack according to illustrative embodiments. The process illustrated in FIG. 4 may be implemented in one or more of the components illustrated in FIG. 1, such as current manager (128).

At block 410, the battery pack is connected to a bus in a series of parallel conductor paths. Each parallel conductor path includes a Peltier module, diode, and resistor, forming a staged dissipation network. The battery pack is bridged across the bus to maintain a float voltage when commercial power is available.

In some embodiments, the process regulates the engagement of the battery pack with the bus using hardware-based switching elements, including a photovoltaic stack with an LED and a MOSFET. The photovoltaic stack controls the MOSFET gate to selectively activate or deactivate conductor paths, enabling staged current dissipation. The connection may be initiated by hardware logic without software intervention.

At block 420, flow direction of current is monitored between the generator and the battery pack. The process performs this monitoring using a hardware-based comparison system that detects voltage differentials across the conductor paths. The process does not require microcontroller intervention and operates autonomously based on real-time electrical conditions. When the generator is supplying power, the system senses the voltage level and determines whether current is flowing toward the battery pack for charging or from the battery pack to the load. The MOSFETs in the current manager (128) function as switches that respond to changes in bus voltage, controlling the state of each conductor path.

At block 430, the battery pack is discharged into a load in response to a failure of an external power supply. When commercial power fails, the hardware-based detection system within the current manager (128) identifies the loss of input voltage and allows the MOSFETs to close, providing power from the battery pack to the load. The discharge path is controlled by the current manager without delay, ensuring that the load receives uninterrupted power. If commercial power is restored before the battery reaches its low voltage disconnect (LVD) threshold, the current manager (128) continues monitoring system conditions to determine the appropriate transition timing.

At block 440, the battery pack is reconnected to the load when the voltage from the battery pack is about equal to the voltage from the bus. Hardware logic is used to detect voltage differentials and control the switching elements accordingly. The photovoltaic stack selectively activates the MOSFETs to ensure that the reconnection occurs when voltage levels are nearly equal, preventing sudden current surges. The staged dissipation of inrush current is achieved by sequentially engaging the parallel conductor paths, each with different voltage drops, to regulate the charging process. The transition is autonomously managed without requiring software-based control, maintaining stable operation through real-time electrical regulation.

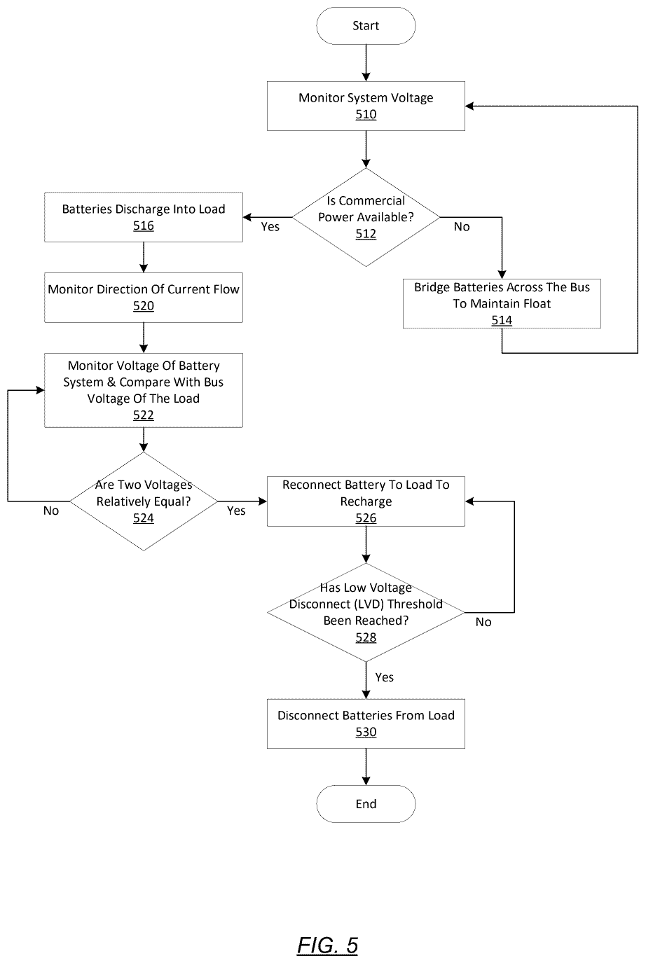

FIG. 5 is a more detailed flowchart for managing current between a generator and a battery pack according to illustrative embodiments. The process illustrated in FIG. 5 may be implemented in one or more of the components illustrated in FIG. 1, such as current manager (128).

At block 510, system voltage is monitored. The process continuously measures the voltage levels of the bus, and battery pack. The monitoring process is hardware-based and uses the photovoltaic stack with an LED and MOSFET to detect voltage changes. The system operates autonomously, engaging or disengaging power flow components based on predefined voltage thresholds.

At block 512, the availability of commercial power is available is determined. The process assesses the incoming voltage from the generator or commercial power supply. If power is available, the process proceeds to step 514. If power is unavailable, the process directs the battery pack to discharge into the load at step 516. The determination is made using a voltage comparator circuit, which activates or deactivates MOSFET switches based on detected conditions.

At block 514, when commercial power is detected, batteries are bridged across the bus to maintain a float voltage, the process ensures that the battery pack remains connected to the bus without drawing excess current. The photovoltaic stack controls the MOSFET gates to regulate current flow. The system prevents unnecessary battery cycling by keeping the pack in a charged state while external power is present.

At block 516, when commercial power is lost, the battery pack is discharged into the load in response to a power failure. The MOSFETs controlled by the photovoltaic stack close the circuit, allowing stored energy from the battery pack to flow into the load. The discharge path is hardware-regulated to prevent voltage spikes.

At block 520, the direction of current flow is monitored. The process determines whether current is flowing from the battery pack to the load or from an external power source to the battery pack. This monitoring is performed using a bidirectional current sensor integrated into the circuit. The photovoltaic stack adjusts MOSFET operation based on the detected current direction.

At block 522, the voltage of the battery system is compared with the bus voltage of the load. The comparison is performed using hardware logic that, upon restoration of external power, determines whether the voltages are sufficiently close to allow reconnection. The photovoltaic stack controls the MOSFET switches to ensure proper transition timing.

At block 524, the process determines whether the two voltages are relatively equal. The process uses predefined voltage thresholds to assess whether the battery pack voltage matches the bus voltage. If the voltages are not equal, the system continues monitoring and does not reconnect the battery pack. If the voltages are sufficiently close, the process moves to step 526. The comparison is performed using a hardware-based voltage comparator circuit.

At block 526, the battery pack is reconnected to the load to recharge. Once the voltage levels are determined to be relatively equal, current flow from the generator to the battery pack is enabled gradually. The MOSFETs controlled by the photovoltaic stack open the charging path while ensuring that inrush current is managed through staged dissipation across parallel conductor paths.

If commercial power fails again at any time during this cycle, reverse bias is lost on the load support diode assembly. This load support diode assembly holds the load for the time necessary to jump the diode with the bypass relay, FET, etc.

At block 528, a determination is made whether the low voltage disconnect (LVD) threshold has been reached. The process continuously monitors the battery pack voltage. If the voltage falls below the LVD threshold, the system proceeds to step 530. If the voltage remains above the threshold, the charging process continues. The LVD threshold is enforced using a hardware-based cutoff circuit that prevents excessive discharge.

At block 530, the battery pack is disconnected from the load. If the battery voltage reaches the LVD threshold, the process disengages the battery pack by opening the photovoltaic control of the MOSFET switches. This prevents further discharge and protects the battery from damage.

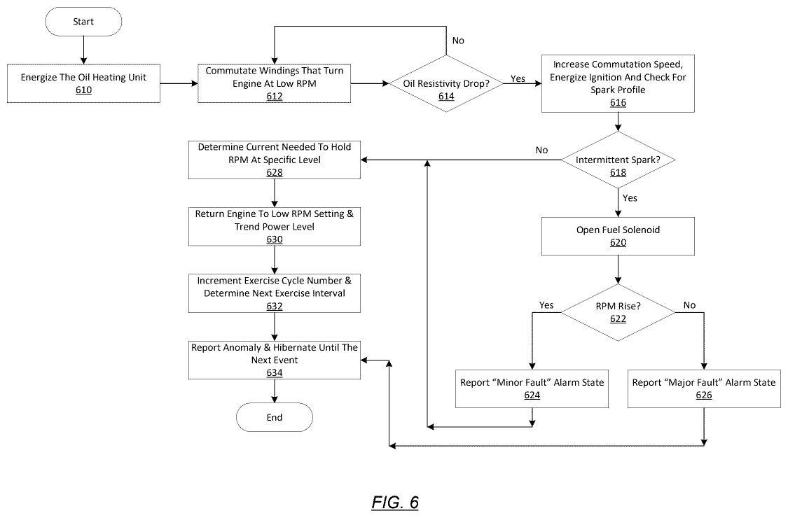

FIG. 6 is a flowchart for generator maintenance cycling according to illustrative embodiments. The process illustrated in FIG. 6 may be implemented in one or more of the components illustrated in FIG. 1, such as generator (105) and current manager (128).

At block 610, the oil heating unit is energized. The power system controller activates heater elements installed in the oil sump to raise the oil temperature. Heating the oil reduces moisture accumulation and ensures proper lubrication during the maintenance cycle. The heating unit remains active until the oil reaches a predefined temperature.

At block 612, commutates the windings that turn the engine at low RPM. The stator windings of the electrical motor are modulated using trapezoidal waveforms to rotate the mechanical motor without combustion. The low-speed rotation circulates the heated oil through the system, allowing lubrication of internal components.

At block 614, the process checks if the oil resistivity drops. Sensors measure the electrical resistivity of the oil, which decreases as moisture is removed. If the resistivity remains high, the system continues rotating the engine at low RPM until the condition is met. If resistivity has dropped, the system proceeds to step 616. An alternative method may include measuring oil dielectric properties as an additional indicator of moisture content.

At block 616, the process increases commutation speed, energizes ignition, and checks for spark profile. The stator windings increase their commutation rate to simulate normal engine operation. The ignition system is activated, and sensors measure the spark plug firing pattern. The spark profile is analyzed to determine whether ignition is occurring properly. An alternative approach may include using an optical or acoustic sensor to verify ignition without requiring direct electrical measurement.

At block 618, the process determines if there is an intermittent spark. If the ignition system is not generating a consistent spark, the process returns to low-speed rotation and reports an anomaly at step 634. If a spark is detected, the system proceeds to step 620. An alternative method may involve adjusting the ignition timing based on historical performance data.

At block 620, the fuel solenoid is opened. If the ignition system is functioning, the controller momentarily opens the fuel solenoid to allow a small amount of fuel into the engine, verifying fuel delivery to the combustion chamber and engagement of the mechanical motor.

At block 622, the process checks for a rise in engine speed (RPM). An increase of the engine speed when fuel is introduced confirms that combustion is occurring. If RPM rises, the system proceeds to step 624. If there is no increase in RPM, the system moves to step 626.

At block 624, the system reports a “minor fault” alarm state. If the engine responds to fuel but does not sustain stable operation, the system logs a minor fault. This indicates that maintenance may be required but that the generator is still functional. The system then proceeds to step 628.

At block 626, the system reports a “major fault” alarm state. If the engine fails to increase RPM after fuel is introduced, this indicates a critical issue. The system logs a major fault and alerts maintenance personnel. The process then proceeds to step 634.

At block 628, the system determines the current needed to hold RPM at a specific level. The power system controller measures the electrical load required to maintain a given RPM. This value provides an indication of engine health, including compression and mechanical resistance. An alternative approach may involve comparing real-time power consumption to historical trends for anomaly detection.

At block 630, the system returns the engine to low RPM setting and trends power level. After recording the required power to maintain speed, the system reduces commutation speed and trends the data for future analysis. An alternative method may involve averaging power consumption over multiple cycles to detect gradual degradation in performance.

At block 632, the system increments the exercise cycle number and determines the next exercise interval. The controller updates the cycle count and calculates when the next maintenance run should occur. The interval may be based on elapsed time, environmental conditions, or generator usage. An alternative method may involve adjusting the interval dynamically based on observed wear indicators.

At block 634, the system reports anomalies and hibernates until the next event. If any faults or irregularities were detected, the system logs them and enters a standby state. If no issues were found, the system remains in hibernation until the next scheduled maintenance cycle. An alternative approach may include performing a brief self-test at periodic intervals between full maintenance cycles.

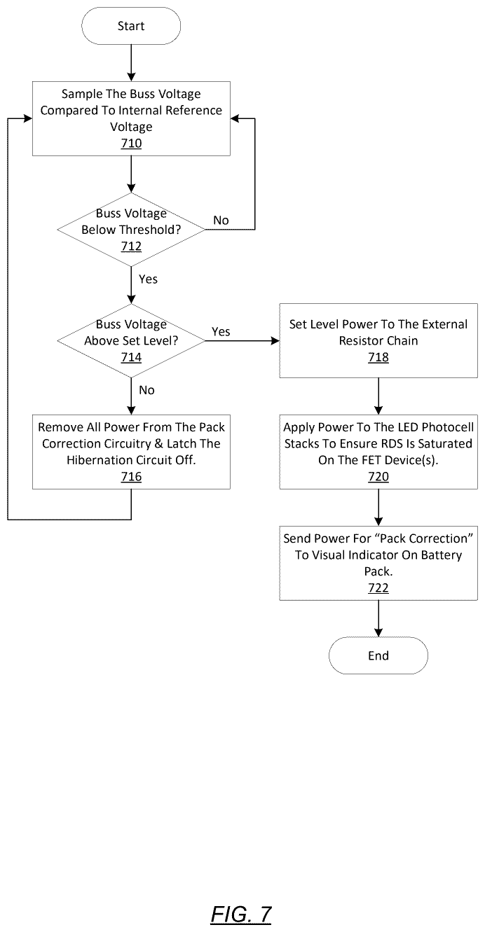

FIG. 7 is a flowchart for battery storage hibernation according to illustrative embodiments. The process illustrated in FIG. 7 may be implemented in one or more of the components illustrated in FIG. 1, such as current manager (128).

At block 710, the system samples the bus voltage and compares it to an internal reference voltage. The current manager determines the voltage level of the bus to assess whether the battery pack requires intervention. The voltage measurement is performed by a hardware-based circuit that continuously monitors bus voltage levels. The internal reference voltage is predefined based on system requirements. An alternative approach may include integrating a programmable reference voltage that adjusts based on environmental conditions or historical data.

At block 712, the system checks if the bus voltage is below a threshold. If the voltage is below the predefined level, the system proceeds to step 716. If the voltage is above the threshold, the system evaluates whether the voltage exceeds an upper set level at step 714. The threshold detection is performed using a comparator circuit that triggers based on the sampled voltage. An alternative method may involve filtering transient voltage fluctuations before making a determination.

At block 714, the system checks if the bus voltage is above the set level. If the voltage is above the predefined threshold, the system proceeds to step 718. If the voltage remains below the threshold but is not critically low, the system proceeds to step 716. The determination is made using a second voltage comparator that identifies when voltage levels cross the upper threshold.

At block 716, the system removes all power from the pack correction circuitry and latches the hibernation circuit off. The current manager disconnects power to the correction circuit when the bus voltage is below the lower threshold, preventing unnecessary energy consumption. A latching mechanism ensures that the correction circuit remains off until voltage conditions change. This process is controlled by a MOSFET switch activated by the photovoltaic stack.

At block 718, the system powers to the external resistor chain. When the bus voltage is above the set level, the current manager directs a controlled amount of power to the resistor chain. The resistor chain provides a predefined electrical load to stabilize voltage and prevent excessive charging currents. The power distribution is managed by a regulated switching circuit.

Step 720 applies power to the LED photocell stacks to ensure RDS is saturated on the FET devices. The LED photocell stacks activate the gate of the MOSFET switches, ensuring that the resistance of the MOSFETs is at a predefined saturation level. This process allows controlled conduction and prevents unintended switching states. The current manager ensures that the applied power is sufficient to maintain MOSFET operation.

The applied power to the LED photocell stacks is sufficient to drive gate voltages of the MOSFETs. The ON resistance (RDS ON) of the MOSFET contributes to the pack error voltage. Sufficient drive ensures RDS saturation on the MOSFET device(s), enabling a ratio of the bypass resistors and the on resistance of the MOSFET's that is less that the acceptable cell-to-cell voltage difference.

At block 722, the system sends power for “pack correction” to a visual indicator on the battery pack. The system provides an external signal to indicate that the pack correction process is active. The visual indicator may be an LED or another display element that provides a status update to maintenance personnel. The signal is managed by the current manager and follows predefined logic for fault reporting.

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 8A, the computing system (800) may include one or more computer processors (802), non-persistent storage (804), persistent storage (806), a communication interface (812) (e.g., Bluetooth interface, infrared interface, network interface, optical interface, etc.), and numerous other elements and functionalities that implement the features and elements of the disclosure. The computer processor(s) (802) may be an integrated circuit for processing instructions. The computer processor(s) (802) may be one or more cores or micro-cores of a processor. The computer processor(s) (802) includes one or more processors. The one or more processors may include a central processing unit (CPU), a graphics processing unit (GPU), a tensor processing unit (TPU), combinations thereof, etc.

The input device(s) (810) may include a touchscreen, keyboard, mouse, microphone, touchpad, electronic pen, or any other type of input device. The input device(s) (810) may receive inputs from a user that are responsive to data and messages presented by the output device(s) (808). The inputs may include text input, audio input, video input, etc., which may be processed and transmitted by the computing system (800) in accordance with the disclosure. The communication interface (812) may include an integrated circuit for connecting the computing system (800) to a network (not shown) (e.g., a local area network (LAN), a wide area network (WAN) such as the Internet, mobile network, or any other type of network) and/or to another device, such as another computing device.

Further, the output device(s) (808) may include a display device, a printer, external storage, or any other output device. One or more of the output devices may be the same or different from the input device(s). The input and output device(s) may be locally or remotely connected to the computer processor(s) (802). Many diverse types of computing systems exist, and the aforementioned input and output device(s) may take other forms. The output device(s) (808) may display data and messages that are transmitted and received by the computing system (800). The data and messages may include text, audio, video, etc., and include the data and messages described above in the other figures of the disclosure.

Software instructions in the form of computer readable program code to perform embodiments may be stored, in whole or in part, temporarily or permanently, on a computer program product that includes a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention, which may include transmitting, receiving, presenting, and displaying data and messages described in the other figures of the disclosure.

The computing system (800) in FIG. 8A may be connected to or be a part of a network. For example, as shown in FIG. 8B, the network (820) may include multiple nodes (e.g., node X (822), node Y (824)). Each node may correspond to a computing system, such as the computing system shown in FIG. 8A, or a group of nodes combined may correspond to the computing system shown in FIG. 8A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (800) may be located at a remote location and connected to the other elements over a network.

The nodes (e.g., node X (822), node Y (824)) in the network (820) may be configured to provide services for a client device (826), including receiving requests and transmitting responses to the client device (826). For example, the nodes may be part of a cloud computing system. The client device (826) may be a computing system, such as the computing system shown in FIG. 8A. Further, the client device (826) may include and/or perform all or a portion of one or more embodiments of the invention.

The computing system of FIG. 8A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown as well as how data is presented to a user. Furthermore, the GUI may present data directly to the user, e.g., data presented as actual data values through text or rendered by the computing device into a visual representation of the data, such as through visualizing a data model.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, “or” is an “inclusive or” and, as such includes “and.” Further, items joined by an or may include any combination of the items with any number of each item unless expressly stated otherwise.

The figures of the disclosure show diagrams of embodiments that are in accordance with the disclosure. The embodiments of the figures may be combined and may include or be included within the features and embodiments described in the other figures of the application. The features and elements of the figures are, individually and as a combination, improvements to the technology of keyword extraction using tags and n-grams. The various elements, systems, components, and steps shown in the figures may be omitted, repeated, combined, and/or altered as shown from the figures. Accordingly, the scope of the present disclosure should not be considered limited to the specific arrangements shown in the figures.

In the above description, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. Further, other embodiments not explicitly described above can be devised which do not depart from the scope of the invention as disclosed herein. Accordingly, the scope of the invention should be limited only by the attached claims.

What is claimed is:

1. A power backup system comprising:
a generator;
a battery pack;
a bus connecting the generator to the battery pack, wherein the battery pack is connected to the bus in a series of parallel conductor paths, wherein a voltage drop across a selected conductor path is different than other voltage drops across the other conductor paths; and
a current manager that is configured to manage a current between the generator and the battery pack based on bus voltage.

2. The power backup system of claim 1, wherein the battery pack is bridged across the bus to maintain a float voltage, and wherein managing the current between the generator and the battery pack further comprises:
monitoring a flow direction of current between the generator and the battery pack;
discharging the battery pack into a load in response to a failure of an external power supply; and
reconnecting the battery pack to the load when voltage from the battery pack is about equal to voltage from the bus, wherein the parallel conductor paths sequentially dissipate current supplied to the battery pack.

3. The power backup system of claim 1, wherein each of the parallel conductor paths comprises a Peltier module, a diode, and a resistor.

4. The power backup system of claim 1, wherein the parallel conductor paths dampen an inrush current during discharging or recharging of the battery pack, reducing a max current supply required by the generator.

5. The power backup system of claim 1, wherein the generator further comprises:
a mechanical motor comprising an oil sump and heater elements associated with the oil sump; and
an electrical motor comprising a stator assembly, a rotor, and position sensors associated with the stator assembly.

6. The power backup system of claim 5, wherein the current manager is further configured to:
energize the heater elements to heat oil in the oil sump to a desired temperature;
commutate stator windings of the stator assembly to turn the mechanical motor; and
determine moisture in the oil sump by monitoring a resistivity of the oil.

7. The power backup system of claim 5, wherein the current manager is further configured to:
check a spark profile for a spark plug of the mechanical motor.

8. The power backup system of claim 5, wherein the current manager is further configured to:
determine a compression stroke pressure for the mechanical motor, wherein the determination is based on a current needed to maintain a rotational frequency of the rotor of the electrical motor.

9. The power backup system of claim 1, wherein the current manager is further configured to:
compare voltage from the bus to a reference threshold voltage for circuit hibernation.

10. The power backup system of claim 9, wherein each of the parallel conductor paths is photocoupled the bus by a respective photocell stack, each photocell stack comprising:
a metal-oxide-semiconductor field-effect transistor (MOSFET); and
a light emitting diode (LED)

11. The power backup system of claim 9, wherein the current manager is further configured to:
provide power from the bus to the series of parallel conductor paths when voltage from the bus is above the reference threshold voltage.

12. The power backup system of claim 9, wherein the current manager is further configured to:
remove power from the bus to the series of parallel conductor paths when voltage from the bus is below the reference threshold voltage.

13. A current manager for managing a current between a generator and a battery pack based on bus voltage, the current manager comprising:
a series of parallel conductor paths connecting the battery pack to the bus, wherein each of the parallel conductor paths comprises:
a resistor;
a Peltier module that is configured to be coupled to an oil sump of a mechanical motor of a compressor; and
a photocell stack that is configured to be photocoupled to a bus that supplies external power;
wherein the voltage drop across a selected conductor path is different than the voltage drops across the other conductor paths.

14. The current manager of claim 13, wherein the parallel conductor paths dampen an inrush current during discharging or recharging of the battery pack, reducing a max current supply required by the generator.

15. A current manager of claim 13, wherein the current manager that is configured to:
monitor a flow direction of current between the generator and the battery pack;
discharge the battery pack into a load in response to a failure of an external power supply; and
reconnect the battery pack to the load when voltage from the battery pack is about equal to voltage from the bus, wherein the parallel conductor paths sequentially dissipate current supplied to the battery pack.

16. The current manager of claim 13, wherein the current manager is further configured to:
energize the Peltier module to heat oil in the oil sump to a desired temperature;
commutate stator windings of a stator assembly of an electric motor to turn a mechanical motor; and
determine moisture in the oil sump by monitoring a resistivity of the oil.

17. The current manager of claim 13, wherein the current manager is further configured to:
check a spark profile for a spark plug of the mechanical motor; and
determine a compression stroke pressure for the mechanical motor, wherein the determination is based on a current needed to maintain a rotational frequency of a rotor of an electrical motor of the compressor.

18. The current manager of claim 13, wherein the current manager is further configured to:
compare voltage from the bus to a reference threshold voltage for circuit hibernation.

19. The current manager of claim 18, wherein the current manager is further configured to:
provide power from the bus to the series of parallel conductor paths when voltage from the bus is above the reference threshold voltage; and
remove power from the bus to the series of parallel conductor paths when voltage from the bus is below the reference threshold voltage.

20. A method for managing current between a generator and a battery pack, the method comprising:
connecting the battery pack to a bus in a series of parallel conductor paths;
monitoring a flow direction of current between the generator and the battery pack;
discharging the battery pack into a load in response to a failure of an external power supply; and
reconnecting the battery pack to the load when voltage from the battery pack is about equal to the voltage from the bus, wherein the parallel conductor paths sequentially dissipate current supplied to the battery pack.
